(19) United States
(12) Patent Application Publication
(10) Pub. No.: US 2015/0188227 A1
(43) Pub. Date: Jul. 2, 2015

(54) ANTENNA FOR NEAR FIELD COMMUNICATION, ANTENNA ARRANGEMENT, TRANSPONDER WITH ANTENNA, FLAT PANEL AND METHODS OF MANUFACTURING

(71) Applicant: Identive Group, Inc., Santa Ana, CA (US)

(72) Inventors: Andreas Schaefer, Sauerlach (DE); Michael Kober, Bruckmuehl (DE); Thomas Germann, Aschau (DE)

(73) Assignee: Identive Group, Inc., Santa Ana, CA (US)

(21) Appl. No.: 14/145,588

(22) Filed: Dec. 31, 2013

(51) Int. Cl. H01Q 7/00; H01Q 1/22; G06K 19/077; H01Q 7/06

(52) U.S. Cl. CPC H01Q 7/00; H01Q 7/06; H01Q 1/2225; G06K 19/07783

(57) ABSTRACT

Described herein are an antenna for a transponder, in particular a near field communication (NFC) or radio frequency identification (RFID) device transponder, a transponder comprising the antenna and a flat panel or poster comprising the transponder, and methods of manufacturing the antenna, the transponder and/or the flat panel or poster.

### TECHNICAL FIELD

The application relates generally to an antenna for a transponder, in particular a near field communication (NFC) or radio frequency identification (RFID) device transponder. The application also relates to a transponder comprising the antenna and a flat panel or poster comprising the transponder. The application also relates to methods of manufacturing the antenna, the transponder and/or the flat panel or poster.

### BACKGROUND

Short distance data communication is widely used for wireless data exchange. Near field communication (NFC) is a set of standards for establishing radio communication between two electronic devices by bringing them into close proximity. Communication is particularly possible between an NFC device and an unpowered NFC chip, also referred to as transponder or tag.

NFC standards cover communication protocols and data exchange formats, and are based on existing radio-frequency identification (RFID) standards including, for example ISO/IEC 14443. Other relevant standards are ISO/IEC 15693/ISO/IEC 18000-3. The standards also include ISO/IEC 18092 and others defined by the NFC Forum founded in 2004. NFC is a set of short-range wireless technologies, typically requiring a distance of 10 cm or less. NFC typically operates at 13.56 MHz and at rates ranging from 106 kbit/s to 424 kbit/s. NFC involves an initiator and a target. The initiator actively generates an RF field that powers a passive target (herein also referred to as transponder or tag). Devices equipped with this kind of transponder (for example, smart cards, key fobs, tags) do not require batteries. NFC tags may contain a specific kind of data and are often read out by a reading device (reader). The NFC or RFID tags typically securely store data such as debit and credit card information, loyalty program data, PINS and networking contacts, among other information.

As with proximity card technology, near-field communication uses magnetic induction between two loop antennas located within each other's near field, effectively forming an air-core transformer. It operates within the globally available and unlicensed radio frequency ISM band of 13.56 MHz. Most of the RF energy is concentrated in the allowed ±7 kHz bandwidth range, but the full spectral envelope may be as wide as 1.8 MHz when using ASK modulation. NFC communication has a theoretical working distance with compact standard antennas of up to 20 cm, while a standard working distance is about 4 cm.

There are two modes: passive mode and active mode. In passive mode, the initiating device, i.e. the reader, provides an electromagnetic field and the target device answers by modulating the existing field. The target device can draw its operating power from the electromagnetic field provided by the reader. In active communication, both reader and transponder communicate by alternately generating their own fields. In this mode, both devices typically have their own, at least short time, power supplies.

In passive mode, usually the tag or transponder antenna consists of a single coil whose dimension should at least substantially match the dimension of the reader antenna in order to optimize energy transfer to transponder. In other words, the size of the transponder antenna or rather transponder coil cannot simply be increased. The short maximum distance between reader and transponder as well as the limited size of the antennas of both devices require that the reader is precisely placed on the transponder to allow for reliable data communication. A precise relative placement of reader and transponder antenna is, however, not possible in various application.

### SUMMARY

It is an object of the methods, systems, and techniques described herein to provide an antenna for a transponder and a transponder, a method of manufacturing the antenna and the transponder, as well as a flat panel comprising the transponder which reduces the requirement for a precise relative placement of reader antenna and transponder antenna with respect to each other.

In one aspect of the invention, an antenna for a transponder, in particular an NFC transponder or RFID tag, is provided. The antenna comprises a plurality of substantially planar coils arranged plane-parallel. The coils are also arranged side-by-side. In this context, plane-parallel means that the coils of the antenna or antenna arrangements described below can be arranged in several planes which are at least substantially parallel. Side-by-side means that the adjacent or neighboring coils do not or only insignificantly overlap. The windings themselves of adjacent coils can however slightly overlap if the adjacent windings are, for example, arranged in different planes. Arranging the adjacent coils side-by-side does therefore not exclude embodiments in which the only the windings of the coils are superimposed in different planes of a substrate (for example, such that the windings of one coil run above or underneath the windings of an adjacent coil separated by an insulating layer). In an advantageous embodiment, the windings of adjacent coils do not overlap or are not superimposed at all.

This specification distinguishes between an antenna (or antenna inlay or inlay) that comprises a plurality of coils which are substantially arranged side-by-side and plane-parallel and an antenna arrangement comprising multiple antennas or antenna inlays. The different antennas (or antenna inlays) of an antenna arrangement can then be further displaced with respect to each other, as explained below. The windings or wires of the coils of the different antennas (or antenna inlays) of an antenna arrangement can overlap to a larger extent than those of a single antenna. This will be explained in more detail below.

In a first aspect, adjacent coils have an opposite sense of winding if adjacent windings of the adjacent coils run close to each other over a substantial distance. In other words, adjacent coils have an opposite sense of winding, if adjacent windings of the adjacent coils run close to each other over a substantial length of the geometrical (e.g., rectangular, triangular, polygonal, oval, circular) outer shape of the each of the adjacent coils. This means that the adjacent windings of the adjacent coils run proximate to each other over a substantial distance of the outer circumferential geometrical shape of the adjacent coils. The outer circumferential geometrical shape of a coil is the shape defined by the outermost windings of the coil. The substantial distance is greater than half of the length of one side of the outer geometrical shape of the coil defined by windings. The adjacent windings of adjacent coils are proximate to each other if the adjacent windings are closer than half the maximum diameter of the outer circumferential geometrical shape of at least one of the adjacent coils.

The distance or length over which the windings of adjacent coils run at least substantially in parallel relates to the geometry of the coil. If, for example, adjacent coils have a substantially rectangular shape, the substantial distance may be the majority or at least half of the length of one side of the rectangle (more than 50% of the side length of the outer geometry of the coil). If the coils have a substantially triangular shape, the substantial distance is at least half of the length of one side of the triangle. In other words, if the windings of two adjacent coils (adjacent in the meaning of side-by-side as discussed above) run close or proximate to each over a substantial length, for example 50% or more of the length of one side of a coil (the outer geometric form of the coil), the sense of winding of the two adjacent coils should be opposite.

In this context, the term “running close” or “running proximate” to each other relates to configurations where the portion of the windings of the two adjacent coils is closer than half the maximum diameter of each of the adjacent coils. This is also the case, if the windings of the portion of the windings of two adjacent coils run substantially in parallel or even perfectly parallel and in very close distance (as close as possible due to limitations given by production or mechanical or electrical constraints) to each other. Running substantially in parallel generally covers embodiments in which the maximum angle of the adjacent windings of adjacent coils is not greater than 45° or 30° with respect to each other. The distance of adjacent windings of adjacent coils can be the range of the maximum thickness (or a multiple thereof) of a single winding. Adjacent windings of adjacent coils can advantageously be closer than 1 cm, and in particular closer than 5 mm.

In an embodiment, the coils of an antenna or antenna arrangement may be arranged on a first side of a substrate and a second opposite side of substrate. Pairs of adjacent coils may, for example, be arranged such that one coil of the pair is on the first side of the substrate and the other coil of the pair is on the second side of the substrate. In another embodiment, all coils of an antenna may be arranged in the same plane. Each pair of adjacent coils of the plurality of coils can then have an opposite sense of winding. In the context of this specification, the term adjacent means that the coils are direct neighbors. In other words, the antenna tracks (or wires) are aligned such that neighboring sub-coils have contrary turn-sense (sense of winding), the neighboring tracks (or wires) have the same current flow direction and destructive interference is avoided while constructive interference is supported.

The coils are arranged such that a current induced by the same external electromagnetic field in adjacent coils flows in the same direction in adjacent wires of the pair of adjacent coils. In other words, in the region where the wires of two adjacent coils run in parallel, the induced current flows in the same direction in all adjacent wires. Dependent on the position of the reader antenna relative to the coils of the antenna, the electromagnetic field emitted by the reader antenna may induce a current in two, three, four or more coils which are pairwise adjacent. This aspect provides that it is not necessary to place the reader antenna precisely on or above one of the coils. The reader antenna that typically has the size of one of the coils can be placed somewhere between two or more coils thereby covering a larger area.

The antenna can be planar comprising planar coils such that the coils are arranged in two or more parallel planes (plane-parallel) or all coils are arranged in a single first plane. The antenna is then flat. The windings of each of the coils of the plurality of coils are then also arranged side-by-side in the plane. The coils may be printed, etched, galvanically grown, punched, laser-cut or applied as a thin layer on a substrate as well as made of winded wires arranged or inlaid in a substrate. This provides that the antenna can be manufactured in an efficient and cheap manner.

Advantageously, the coils of the plurality of coils are arranged side-by-side such that the adjacent windings of adjacent pairs of coils do not overlap each other. This also supports easy production of the antenna, for example, by printing, etching, galvanical growth, punching, or laser cutting.

The coils may generally have various shapes, sizes or sense of windings within the same antenna. However, in an advantageous embodiment, all coils of the plurality of coils can have substantially the same shape and dimension. In an advantageous embodiment, the shape of the coils is rectangular. However, the shape of the coils can also be circular, oval, triangular, square, or polygonal.

The coils of the plurality of coils can be arranged in the same plane in form of a regular pattern, for example, a checkerboard pattern (also called a chessboard pattern). The centers of the coils can then be placed on a grid such that all centers of a row and/or a column of coils have the same distance to each other. In this configuration, the plurality of coils is advantageously arranged in columns and rows side-by-side in a non-overlapping manner. The coils can then advantageously be arranged such that pairs of adjacent coils in the same row or the same column have an opposite sense of winding.

The number of windings per coil is preferably small. The number of windings can for example be smaller than 20, in particular be smaller than 10. In an advantageous embodiment, the number of windings can be 2 or 3. In an embodiment, the number of windings can be 2.5, which means that one winding encompasses the coil only half-way of the circumference.

Advantageously, two adjacent coils can share a wire which is located between the coils and couples the coils to each other. In other words, a wire of one coil can be used as a wire of an adjacent coil connecting the first and second coil.

The shape and/or dimensions of the coils advantageously correspond to the dimensions and/or shape of a coil of a reader antenna. Each coil of the plurality of coils can then be configured to optimally receive the electromagnetic field from a reader. In other words, each coil can be configured to perform wireless communication between a reader and an integrated circuit to which the antenna is coupled.

Dependent on the specific geometry of the antenna and the coils, three principles of defining adjacent coils having an opposite sense of winding can be derived.

In an embodiment in which the coils all have the same shape and dimensions and are arranged in a regular pattern, for example, a checkerboard pattern side-by-side (non-overlapping) in rows and columns (rows and columns are perpendicular to each other), adjacent coils having an opposite sense of winding are directly neighboring coils within the same row or the same column.

In an embodiment, in which the coils have the same triangular shape and the same dimension and are arranged in rows and columns while within the same row the coils are oriented alternately in opposite direction (180° turned from one coil to the next neighboring coil) and within the same column the coils have the same orientation, adjacent coils either have the same row index and a column index that differs by 1 (plus or minus 1) or the adjacent coils have a row index that differs by one (plus or minus 1) and a column index that also differs by 1 (plus or minus 1).

In an embodiment in which the coils are segments of a larger geometrical shape as, for example, a disk or a triangle and in which the coils in form of the segments are arranged around a center (or circumcenter) of the geometrical shape, adjacent coils are directly neighboring coils along a circumferential path around the center of the geometrical shape.

The coils of the plurality of coils are coupled with each other either in series or in parallel. In particular, any number of coils of the plurality of coils may be coupled in series (thereby creating serial sub-loops or groups) and/or any number of coils of the plurality of coils may be coupled in parallel. The serial sub-loops of an antenna together form a single coil that is flattened and arranged as flat sub-coils having a lower number of windings in a plane or plane-parallel in multiple planes. The antenna generally comprises a multi-coil structure to ensure good connectivity or power transfer from a reader to the NFC/RFID chip. The wires of serial sub-loops (coils) can either be directly connected to a chip or in parallel together with other serial sub-loops.

The plurality of coils may be coupled to form groups of coils being coupled in series. The groups of coils being coupled in series can then be coupled in parallel such that all coils of the plurality of coils are finally coupled together. The antenna can then be coupled to a single electronic circuit or electronic device, in particular to an integrated circuit, such as an NFC/RFID chip.

The antenna is advantageously coupled to a capacitance. The coils of the antenna and the capacitance may then form an LC resonator. The capacitance may be formed of a single or a plurality of capacitors. The capacitance may be formed of at least two overlapping layers. The capacitance is also flat and arranged in the same plane as the coils of the antenna. The layers of the capacitance may be made of the same material or materials as the coils. This simplifies production of the antenna and the capacitance. The capacitance may then be used for tuning the antenna to a target resonance frequency.

In some embodiments, the NFC/RFID chip (integrated circuit) may comprise an internal capacitance. If this capacitance is large enough for the required resonant frequency, the external capacitance may not be used.

The plurality of capacitors may advantageously be placed within one or more of the coils of the antenna. This saves spaces and allows the coils of the antenna to be arranged regularly and close to each other.

The techniques described herein also provide for an antenna arrangement. The antenna arrangement may comprise a first plurality of coils and a second plurality of coils. Each of the plurality of coils may then be configured in accordance with the aspects and embodiments described herein. The first plurality of coils may be arranged in a first plane. The second plurality of coils may be arranged in a second plane. The coils of the first plurality of coils in the first plane may be arranged on one side of a substrate. The coils of the second plurality of coils in the second plane may be arranged on an opposite side of the substrate than the first plurality of coils. The first plane and the second plane can be electrically insulated from each other. The first plurality of coils may then form a first antenna in accordance with the aspects and embodiments described herein. The second plurality of coils may then form a second antenna in accordance with the aspects and embodiments described herein. The antennas can then be arranged such the antennas are misaligned or displaced with respect to each other. This means that coils in different parallel planes are not exactly superimposed. This results in further reduction of read-holes and in less negative (coupling) effects with the antenna on the opposite side.

In the antenna arrangement, the first antenna and the second antenna can be electrically coupled (or connected) such that the first antenna and the second antenna form a single antenna. This single antenna can then be coupled to a single NFC/RFID chip. In other words, a single antenna can also be formed by coils on two different sides or two or more different layers of a substrate.

Any antenna described herein may be coupled to at least one electronic device, in particular an integrated semiconductor device, such as an NFC transponder chip or RFID chip. In particular, also two or three semiconductor devices may be coupled to the antenna. With respect to the previously described antenna arrangement, the first antenna may be coupled to a first electronic circuit, in particular a first integrated electronic circuit such as an electronic chip. The second antenna may be coupled to a second electronic circuit, in particular a second integrated electronic circuit such as an electronic chip.

The electronic circuits which are coupled to the antenna or antennas are advantageously integrated semiconductor electronic circuits, also referred to as chips. These integrated circuits are configured to perform the functionality of RFID or NFC wireless data communication through the antenna or antennas. The integrated circuits are configured to process signals received by the antenna and to respond to the reader or transmit data to the reader, for example also through the antenna or antennas. The integrated circuits may particularly be configured to operate in passive mode or semi-active mode. The integrated circuits may further be configured to perform load modulation. The integrated circuits are advantageously placed on the same substrate as the antenna. The integrated circuits are preferably mounted on the substrate without housing, i.e. the integrated circuits are in form of dies and mounted on the substrate in a flip-chip configuration. The wires of the coils of the antenna, which are preferably flat conductive layers, can then provide respective areas on which the die or chip can be placed.

In the antenna arrangement, the first antenna and the second antenna may be similar. The two antennas which are arranged on two sides of an insulating layer or substrate may have the same number of coils and the coils may all have the same shape and dimensions. In particular, the coils may have rectangular shape and the coils may be arranged in a regular grid in form of a regular pattern, for example, a checkerboard pattern. The first antenna may then be displaced with respect to the second antenna. The first antenna and the second antenna are then not exactly superimposed. In other words, the centers of the coils of the first antenna may not coincide with the centers of the coils of the second antenna in a view perpendicular to the plane of the antennas. The displacement or misalignment of the first antenna with respect to the second antenna can be half the grid size. The grid size can be the distance between the centers of two adjacent coils. If the coils are arranged in a regular pattern, as a checkerboard pattern, there can be a first grid size in the direction of the rows and a second grid size in the direction of the columns. The displacement of the first antenna with respect to the second antenna may then be half the first grid size and half the second grid size. This provides that the centers of the coils of the first antenna are then located above the corners of the coils of the second antenna. If a separate electronic circuit is coupled to each of the two antennas, the two electronic circuits may provide similar functionality. The above aspects further minimize read holes.

Another aspect of the invention provides a transponder or tag comprising an electronic circuit and an antenna in accordance with the embodiments described herein.

Yet another aspect of the invention provides a flat panel, in particular a poster having information, signs, patterns and/or art provided thereon. The flat panel or poster may, for example, have the following size: A5, A4, A3, A2 or A1 or larger. The antenna or antenna arrangement may be configured as a module or inlay in a predefined size. Each module or inlay may be provided with a separate electronic circuit. Each of the inlays or modules may then be configured such that a plurality of inlays or modules can be arranged side-by-side in order to cover a larger area (in particular a flat area or plane). The antenna may, for example be configured to have the dimensions corresponding to paper size A5. Two of the modules or inlays may then be used to cover the area of an A4 sheet and four inlays or modules may then be used to cover the area of an A3 sheet etc. The coils of the antenna of an inlay or module may then be configured in a regular pattern as, for example, a checkerboard pattern as described herein. The outer edges of the inlays can then be arranged side-by-side such that the currents of adjacent coils of adjacent inlays or modules still provide that the current through the adjacent wires of adjacent coils of two different inlays flow in the same direction in response to the same electromagnetic field.

The above aspects provide that the expandability of the antenna size is simplified, i.e. the reception area is theoretically unlimited. There can be one general antenna design (inlay, module) that can be used for nearly all different (poster) sizes. The (poster) dimension only needs to fit in the grid pattern that is given by the antenna dimension. The poster dimension is then a multiple of the antenna dimension (inlay, module dimension). The design simplifies lateral adding of multiple inlays to increase the covered area as several antennas can be placed side-by-side without any drawback regarding the reception.

Another aspect of the invention provides a method of manufacturing an antenna, an antenna arrangement, a transponder or a flat panel including the antenna or transponder in accordance with the embodiments described herein.

The substrate on which the coils of the antenna are arranged is advantageously a foil, film, sheet or layer of, for example, PET (polyethylene terephthalate), paper, polyimide, polycarbonate, PVC (polyvinylchloride), teslin (polyolefin plastic material), or PEN (polyethylene naphthalate).

A soft magnetic foil (for example, a ferrite foil) may be placed on the rear side of the foil. This may serve as a diverter of a magnetic field if the antenna is placed on an electrically conductive layer, if the antenna (the substrate with the coils of the antenna on it) is placed on an electrically conductive layer, so that the magnetic field is diverted from entering the electrically conductive layer. The soft magnetic foil may cover the entire area of the antenna if an electrically conductive layer (e.g. metal) is present all over the substrate or carrier or only a part of it, if the electrically conductive layer (e.g. metal) is only partially present. If the electrically conductive layer is formed as frame, the soft magnetic foil may also be configured as a frame substantially covering the electrically conductive frame.

In an embodiment, a foil of PET covered by a metal foil may be provided (for example, on a roll) and the aluminum foil may be etched (by use of masking) so as to form a plurality of coils of an antenna or antenna arrangement.

In another embodiment, the coils of an antenna or antenna arrangement may be printed on a substrate (e.g. a foil) using silver paste or another printable conductive substance.

The coils of the antenna and optionally additional structures of the antenna and/or the capacitors may be formed of aluminum, copper, or silver (silver paste). Furthermore, the coils of the antenna and optionally additional structures of the antenna may be formed by etching, laser cutting, printing (silver paste printing, Ink-Jet printing), punching and/or galvanic coating or growing as well as by vapor deposition

The systems and methods described herein also provide for a large RFID tag which size is multiple times larger than a standard RFID tag. Furthermore, a new antenna design that is suitable to cover large areas is provided. The aspects and embodiments described herein enable placement of several antenna modules or inlays side by side to increase the covered area without limits. Read-holes across the whole antenna-area or poster-area can then be avoided or reduced, and large areas (e.g. posters) can be covered while the number of chips or antennas per large area (e.g. poster) is reduced. Read-holes are especially reduced by avoiding destructive interference and supporting constructive interference of currents or electromagnetic fields.

Other aspects and advantages of the invention will become apparent from the following detailed description taken in conjunction with accompanying drawings illustrating the principals of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic (top view) of a first embodiment.

FIG. 2 is a schematic (top view) of a second embodiment.

FIG. 3 is a schematic (top view) of a third embodiment.

FIG. 4 is a schematic (top view) of a fourth embodiment.

FIG. 5 is a schematic (top view) of a fifth, sixth and seventh embodiment.

FIG. 6 is a schematic (top view) of an eighth and ninth embodiment.

FIG. 7 shows schematics illustrating an application of the embodiments.

### DETAILED DESCRIPTION

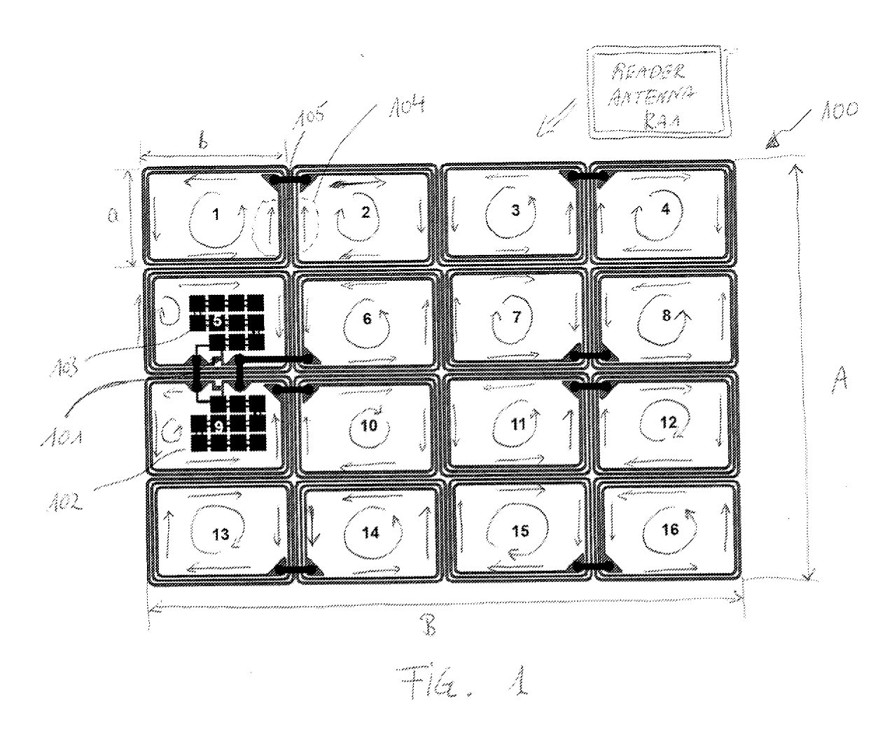

FIG. 1 is a schematic of a first embodiment. The antenna (or antenna inlay or module) 100 is shown in a top view perpendicular to the plane in which the coils 1 to 16 are arranged. The coils 1 to 16 are arranged in a regular pattern, here a checkerboard pattern. In other words, the coils 1 to 16 are arranged in a regular grid as a 4×4 array of coils (16 coils). Each coil 1 to 16 has the same rectangular shape. The height of each coil 1 to 16 is a and the length is b. The total height of the antenna is A and the total length is B. Height A may for example be 150 mm and length B may for example be 210 mm. This corresponds to an antenna module or inlay fitting to the standard paper size A5. Dimension a is then equal to A divided by 4. Dimension b is then equal to B divided by 4.

Coils 1 to 16 are arranged in rows and columns. Coils 1 to 4 are arranged in a first row. Coils 5 to 8 are arranged in a second row. Coils 9 to 12 are arranged in a third row. Coils 13 to 16 are arranged in a fourth row. Coils 1, 5, 9, 13 are arranged in a first column. Coils 2, 6, 10, 14 are arranged in a second column. Coils 3, 7, 11, 15 are arranged in a third column. Coils 4, 8, 12, 16 are arranged in a fourth column.

The grid size is ‘b’ along the rows of the antenna and ‘a’ along the columns of the antenna. The number of coils per row and per column is advantageously an even number. This allows arrangement of the inlays of each antenna side-by-side in order to expand the area covered by the antennas. However, in another advantageous embodiment, the number of coils per row and/or per column can also be uneven, which then requires that the antennas (inlays) are turned upside-down to arrange the antennas (inlays) side-by-side in order to expand the area covered by similar inlays.

Coil 1 is adjacent to coils 2 and 5. Coil 2 is adjacent to coils 1, 6 and 3. Coil 3 is adjacent to coils 2, 7 and 4 etc. In other words, each coil 1 to 16 has direct neighbors within the same row and column. These direct neighbors are the adjacent coils. The next coil in diagonal direction is not “adjacent” in the context of this specification. Adjacent coils have an opposite sense of winding. The sense of winding of each coil 1 to 16 is indicated by a circled arrow within each coil 1 to 16. In other words, the sense of winding of the coils is alternating from one coil to the next coil along the rows and columns. The alternating sense of winding from one coil to an adjacent coil provides that the currents through the adjacent wires of the adjacent coils flow in the same direction. The directions of the currents through the wires of the coils 1 to 16 are indicated by straight arrows (just as an illustrative example, as the direction of the currents depends on the direction of the electromagnetic field). This also applies to configurations different than the regular checkerboard pattern of this embodiment. For example, adjacent coils 1 and 2 have adjacent wires in the area 104 (dashed circle). The currents through the adjacent wires of adjacent coils flow in the same direction if the same electromagnetic field is used to induce a current into the coils 1 and 2. This means that a reader antenna having about the same dimensions and shape as a single coil 1 to 16 (not shown) can be placed somewhere between two adjacent coils and the induced currents of the two adjacent coils are added up to a single stronger current in the antenna 100.

The coils 1 to 16 can be arranged on the same side of a foil, layer, or substrate. This allows printing or etching the coils only from one side. The bridges, here for example referenced as BR12 (electrically conductive bridge between coil 1 and coil 2) and BR34 (electrically conductive bridge between coil 3 and coil 4) can then be arranged on the opposite side of the foil, layer, or substrate. The foil, layer, or substrate is electrically insulating.

An integrated circuit (not shown) can be mounted at position 101 on respective extensions of the wires. Due to the very small dimensions of the integrated circuit (NFC chip, RFID chip), especially without housing, the integrated circuit would hardly be visible due to the dimensions of the antenna.

The capacitance described above is implemented by capacitors 102, 103. At least one capacitor or arrays of capacitors 102, 103 are arranged inside coils 5 and 9 respectively. These capacitors can be used for tuning the antenna. The antenna usually operates as LC resonator at a specific resonating frequency. The coils 1 to 16 provide for the inductivity L while the capacitors provide for the C. The integrated circuit may have enough internal capacitance such that the external capacitors 102, 103 are not used.

The coils 1 to 16 are either directly coupled by extending the wire of a first coil to a second coil or the coils 1 to 16 are coupled by bridges 105. In the present embodiment, coils 1 to 8 are coupled in series and coils 9 to 16 are coupled in series. This means that coils 1 to 8 form a first group of coils which are all coupled in series and coils 9 to 16 form a second group of coils which are all coupled in series. The two groups of coils are then coupled in parallel such that all coils 1 to 16 are coupled together.

The substrate on which the coils of the antenna are arranged is advantageously a foil, film, sheet or layer of, for example, PET (polyethylene terephthalate), paper, polyimide, polycarbonate, PVC (polyvinylchloride), teslin (polyolefin plastic material), or PEN (polyethylene naphthalate).

The coils of the antenna and optionally additional structures of the antenna may be formed of aluminum, copper or silver (silver paste) or other electrically conductive material. Furthermore, the coils of the antenna and optionally additional structures of the antenna may be formed by etching, laser cutting, printing (silver paste printing, Ink-Jet printing), punching and/or galvanic coating or growing.

Also shown is a reader antenna RA1, which has about the same shape and dimension as each of the coils 1 to 16. The reader antenna RA1 can be placed anywhere on the antenna (inlay or module) 100 in order to communicate with an integrated circuit (RFID/NFC chip) which can be coupled to the antenna (inlay or module) 100.

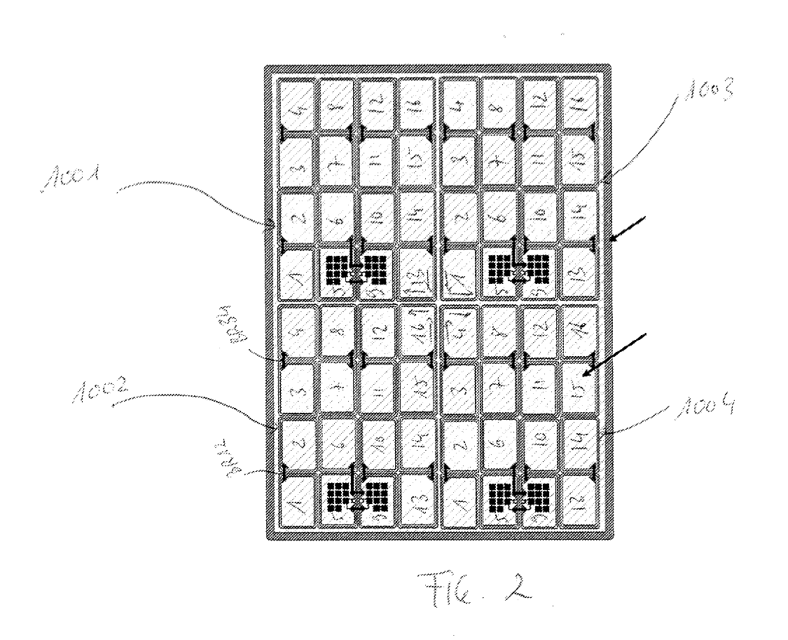

FIG. 2 is a schematic (top view) of a second embodiment. Four antennas or antenna inlays or modules 1001, 1002, 1003, 1004 are now arranged in a 2×2 matrix side-by-side. Each of the inlays 1001, 1002, 1003, 1004 is similar to the antenna 100 shown in FIG. 1. The size of the covered area corresponds to paper size A3 if a single inlay is assumed to have the size A5.

Even across the edges of an inlay, i.e. from inlay to inlay (or antenna to antenna) 1001 to 1004 the adjacent coils have an opposite sense of windings. This allows the inlays or antennas to be placed side-by-side in order to cover large areas. Just as an example, coil 13 of antenna 1001, coil 16 of antenna 1002, coil 1 of antenna 1003 and coil 4 of antenna 1004 are discussed. The adjacent wires of all adjacent pairs of coils (13-16; 16-4, 4-1, 1-13) are flowing in the same direction as indicated by the straight arrows. In order to provide this kind of expandability, it is advantageous that the number of coils in a row and the number of coils in a column of an antenna 1001 to 1004 is even. However, configurations with an uneven number of coils per row and/or column can also be used which then requires to turn neighboring antennas (inlays) upside-down in order to continue the concept of opposite windings of neighboring coils.

A soft magnetic foil (for example, a ferrite foil) may be placed on the rear side of the substrate indicated by a hatched area. This may serve as a diverter of magnetic field if the antenna (the substrate with the coils of the antenna on it) is placed on an electrically conductive layer so that the magnetic field is diverted from entering the electrically conductive layer. The soft magnetic foil may cover the entire area of the antenna if the electrically conductive layer is present all over the substrate or only a part of it, for example as a frame, if the electrically conductive layer is only partially present on the substrate, or also forms a frame. The electrically conductive layer may, for example, be a metal frame of a poster.

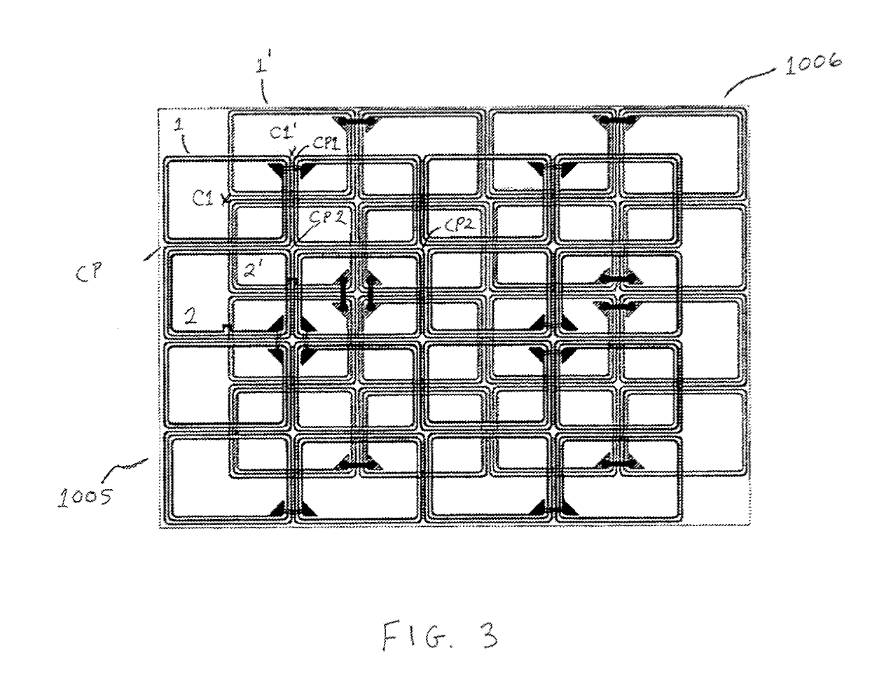

FIG. 3 is a schematic (top view) of a third embodiment. In this embodiment, there is an antenna arrangement comprising two antennas or antenna modules or inlays 1005 and 1006 which are placed on different sides of a layer, foil or substrate. The two antenna modules 1005, 1006 can also be coupled so as to form a single antenna. There is a first antenna 1005 in a first plane and a second antenna 1006 in a second plane. First and second antenna 1005, 1006 are similar to the ones shown in FIG. 1 and FIG. 2. The first antenna 1005 is displaced with respect to the second antenna 1006 in order to reduce read holes. The amount of displacement is about half the grid size (a/2; b/2 as shown in FIG. 1). The center C1 of coil 1 of antenna 1005 is now located above the left upper corner of coil 2′ and the left lower corner of coil 1′ of antenna 1006. Center C1′ of coil 2 of antenna 1006 is beneath a corresponding edge between coils 1 and 2 of antenna 1005. This arrangement provides that destructive interference between the two antennas 1005, 1006 is avoided or at least reduced.

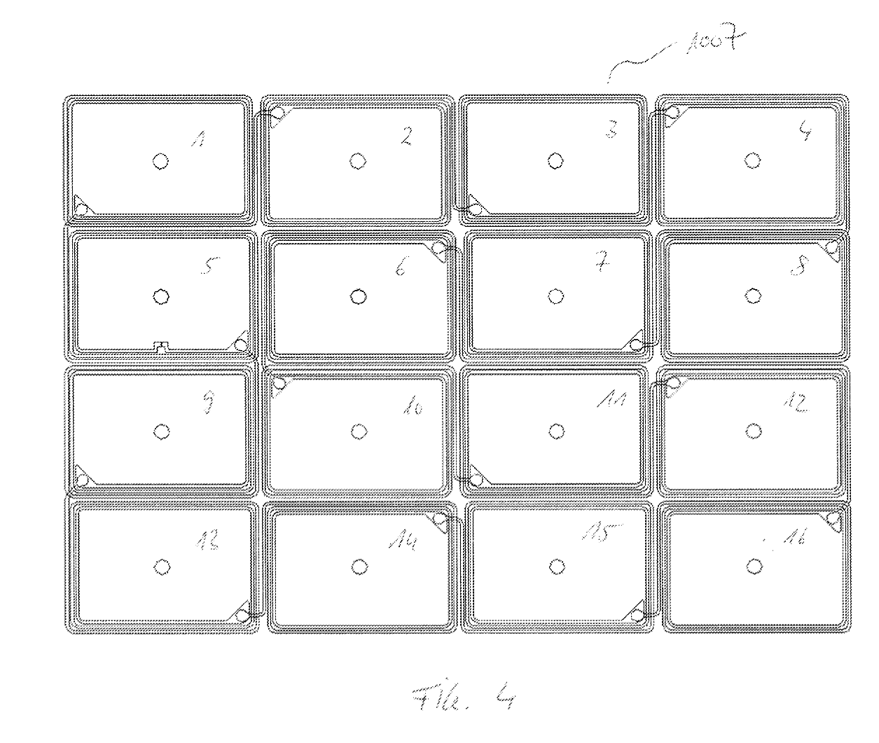

FIG. 4 is a schematic (top view) of a fourth embodiment. The shown embodiment is basically similar to a single antenna module 1001, 1002, 1003 or 1004 shown in FIG. 2 except that the coils of the antenna module 1007 of this embodiment are now arranged on different sides of foil, substrate or layer. Coil 1 is, for example, arranged on a first side of the foil, substrate or layer and coil 2 is arranged on a second opposite side of a substrate or a different layer of a multi-layer foil, substrate or layer. Coil 3 can then be arranged on the same first side or layer of the foil or substrate as coil 1. Adjacent coils of pairs of coils can then be alternately be arranged on different sides or layers or a foil or substrate. For example, coils 1, 3, 6, 8, 9, 11, 14 and 16 can be arranged on a first side or layer of the substrate or foil while coils 2, 4, 5, 7, 10, 12, 13 and 15 are arranged on a second (for example, opposite) side or layer of the substrate or foil. Bridges, as for example bridges BR12 or BR34 shown in FIG. 2 can then be omitted. The coils 1 to 16 of this embodiment are arranged plane-parallel in at least two planes which are parallel to each other.

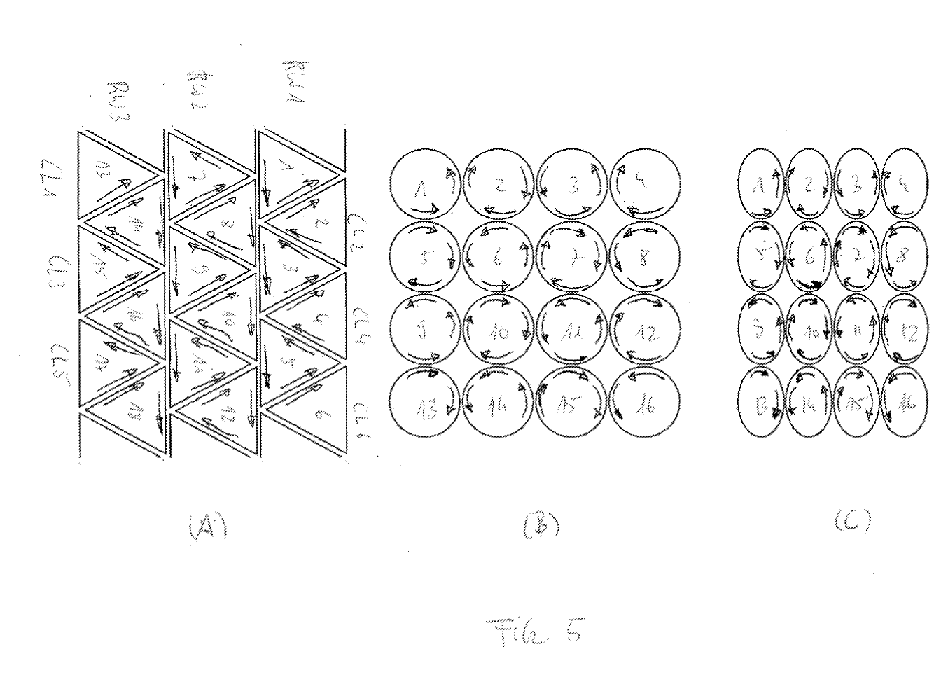

FIGS. 5A to 5C are schematics (top view) of a fifth, sixth and seventh embodiment. The shape of the coils of an antenna can vary. The shape can be defined by the shape of a potential reader. FIG. 5A shows an embodiment in which the coils 1 to 18 have a triangular shape. Triangular coils 1 to 18 are arranged in rows RW1 to RW3 and columns CL1 to CL6. Also in this embodiment, the sense of winding, which is indicated by arrows within each coil, is opposite in adjacent coils. However, the definition of adjacent coils is slightly different than the one used for the embodiments shown in FIGS. 1 to 4. For example, coils 1 and 2 have an opposite sense of winding. Coils 2 and 3 have an opposite sense of winding. The coils are arranged side-by-side in one or more planes (either in a single plane or in multiple planes, i.e. plane-parallel). The orientation of the coils within the same row (first row RW1: coils 1 to 6; second row RW2: coils 7 to 12; third row RW3: coils 13 to 18) is alternately turned by 180° from one coil to the next neighboring subsequent coil, such that the packing of the coils 1 to 16 is optimized. The coils within the same column (first column CL1: coils 1, 7 13; second column CL2: coils 2, 8 14; third column CL3: coils 3, 9 15; fourth column CL4: coils 4, 10, 16; fifth column CL5: 5, 11, 17; sixth column CL6: coils 6, 12, 18) have the same orientation. The coils in the same column also have the same sense of winding. In this embodiment, the coils within the same column are not referred to as adjacent coils. Adjacent coils are the coils within the same row RW1 to RW3. Adjacent coils are also coils of two adjacent different rows and two adjacent different columns. For example, coil 8 is adjacent to coil 1. The position of coil 1 is the first row RW1 and the first column CL1, while the position of coil 8 is the second row RW2 and the second column CL2. This means that, in an embodiment of equally shaped triangular coils having opposite (turned by 180° from one coil to the next neighboring subsequent coil within the same row) orientation within rows and the same orientation within columns, adjacent coils, which need to have an opposite sense of winding, are defined by the following indexing: adjacent coils either have the same row index and a column index that differs by 1 (plus or minus 1) or the adjacent coils have a row index that differs by one (plus or minus 1) and a column index that also differs by 1 (plus or minus 1). This embodiment is particularly suitable for reader antennas having substantially the same triangular shape as the coils 1 to 18. Among others, a particular advantage of this embodiment using triangular coils consists in the increased areas in which the windings of adjacent or neighboring coils run close to each other.

FIG. 5B is a schematic of a sixth embodiment. The coils 1 to 16 are now arranged in a regular pattern, here a checkerboard pattern, i.e. in a regular equidistant grid. The checkerboard pattern is similar to the embodiments shown in FIG. 1 to FIG. 4. The only difference is that the coils 1 to 16 now have a round, circular shape. Among others, this embodiment is suitable for reader antennas having a circular or round shape similar to the one of coils 1 to 16. In a checkerboard pattern arrangement, adjacent coils are directly neighboring coils within the same row or the same column. The indexing for coils which need to have an opposite sense of winding (indicated by arrows in coils 1 to 16 is as follows: Adjacent coils having a different sense of winding are directly neighboring coils of either the same row or the same column. This also applies to the antennas and antenna arrangements shown in FIGS. 1 to 4.

FIG. 5C is a schematic of a seventh embodiment. The coils 1 to 16 now have an oval shape. Among others, this embodiment is particularly suitable for reader antennas having the same oval shape. The coils 1 to 16 are arranged in a checkerboard pattern. This means that the same principle as set out with respect to FIG. 5B and which also applies to the embodiments shown in FIGS. 1 to 4 can be applied to this embodiment. Adjacent coils having a different sense of winding are directly neighboring coils of either the same row or the same column.

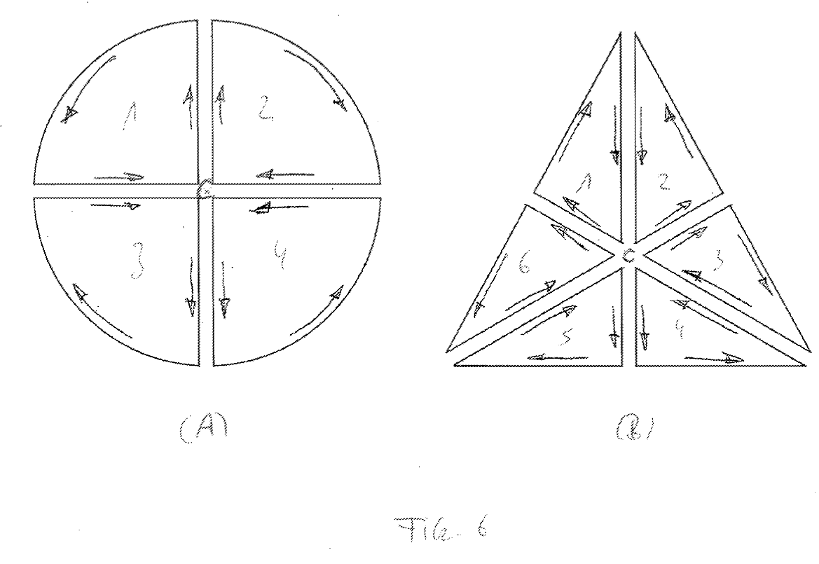

FIGS. 6A and 6B are schematics (top view) of an eighth and ninth embodiment.

FIG. 6A is an embodiment in which the coils 1 to 4 have the shape of circular sectors of an entire circle or rather disk. The windings of the coils 1 to 4, as for all embodiments, are arranged along the circumference, i.e. in this embodiment along the circumference of each circular sector. The sense of winding is again indicated by arrows in coils 1 to 4. In the present embodiment, the entire circular or disk-shaped antenna is sub-divided in four circular sectors (quarter circle or quarter disk). However, any even number of circular sectors, i.e. any even number of coils being shaped as equal circular sectors is applicable. Adjacent coils having an opposite sense of winding are now defined as directly neighboring coils along a path around the center C of the disk-shaped antenna. Among others, this embodiment is suitable for reader antennas having the shape of circular sectors.

A similar principle applies to the embodiment shown in FIG. 6B. The entire antenna has now the shape of a large triangle. The triangle is divided by the three perpendicular bisectors of the three sides of the triangle. The circumcenter of the triangle is C. This results in six segments 1 to 6, which are arranged around the circumcenter C of the triangle. Adjacent coils having an opposite sense of winding are now defined as directly neighboring coils along a path around the circumcenter C of the triangularly shaped antenna. This embodiment is suitable for reader antennas having the shape of segments of a triangle defined by the perpendicular bisectors of the sides of a triangle.

Three principles of defining adjacent coils having an opposite sense of winding can be derived from the disclosed embodiments: (1) If the coils have the same shape and dimensions and are arranged in a regular checkerboard pattern side-by-side (non-overlapping) in rows and columns (rows and columns are perpendicular to each other), adjacent coils having an opposite sense of winding are directly neighboring coils within the same row or the same column. (2) if the coils have the same triangular shape and the same dimension and are arranged in rows and columns while within the same row the coils are oriented alternately in opposite direction (180° turned from one coil to the next neighboring coil) and within the same column the coils have the same orientation, adjacent coils either have the same row index and a column index that differs by 1 (plus or minus 1) or the adjacent coils have a row index that differs by one (plus or minus 1) and a column index that also differs by 1 (plus or minus 1). (3) In an embodiment in which the coils are segments of a geometrical shape as, for example, a disk or a triangle and in which the coils in form of the segments are arranged around a center (or circumcenter) of the geometrical shape, adjacent coils are directly neighboring coils along a circumferential path around the center of the geometrical shape. The number or segments or coils should then be even.

In the above-described embodiments, and in particular in the embodiments shown in FIGS. 1 to 4, 5A and 6A and 6B, the antenna comprises a plurality of substantially planar coils arranged plane-parallel and side-by-side. The windings of adjacent coils can overlap if the windings are, for example, arranged in different planes. Arranging the adjacent coils side-by-side does therefore not exclude embodiments in which the only the windings of the coils are superimposed in different planes of a substrate. In the embodiments shown in FIGS. 1 to 4, 5A and 6A and 6B, adjacent coils have an opposite sense of winding if adjacent windings of the adjacent coils run close to each other over a substantial distance. In other words, adjacent coils have an opposite sense of winding, if adjacent windings of the adjacent coils run close to each other over a substantial length of the outer circumferential geometrical (rectangular, triangular, polygonal, etc.) shape of each of the adjacent coils. This means that the adjacent windings of the adjacent coils run proximate to each other over a substantial distance of the outer circumferential geometrical shape of the adjacent coils. The outer circumferential geometrical shape of a coil is the shape defined by the outermost windings of the coil. In FIGS. 1 to 4 the outer circumferential geometrical shape defined by the windings of the coils is rectangular. In FIG. 5A this shape is triangular. The distance of adjacent windings of adjacent coils is at least half of the length of one side of the outer geometrical shape of the coil defined by windings. The adjacent windings of adjacent coils are proximate to each other as the adjacent windings are closer than half the maximum diameter of the outer circumferential geometrical shape of at least one of the adjacent coils.

The distance or length over which the windings of adjacent coils run at least substantially in parallel relates to the geometry of the coil. If, for example, adjacent coils have a substantially rectangular shape, the substantial distance may be the majority or at least half of the length of one side of the rectangle (more than 50% of the side length of the outer geometry of the coil). In the embodiments shown in FIGS. 1 to 4, the distance is about the length of one side of a rectangular shaped coil. In the embodiment shown in FIG. 5A, the distance is in some cases half the length of one side of a triangle and for neighbors in the same row, it is the full length of one side. If the coils have substantially triangular shape, the substantial distance is at least half of the length of one side of the triangle. In other words, if the windings of two adjacent coils (adjacent in the meaning of side-by-side as discussed above) run close or proximate to each over a substantial length, for example 50% or more of the length of one side of a coil (the outer geometric form of the coil), the sense of winding of the two adjacent coils should be opposite.

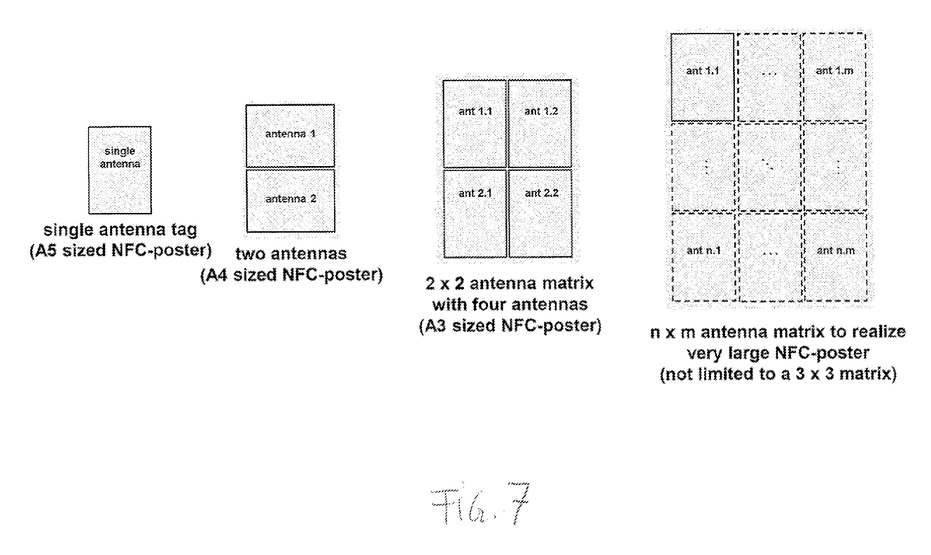

FIG. 7 shows schematics illustrating an application of the embodiments. The antennas (or inlays, modules, transponders) according to the aspects and embodiments described herein, may advantageously be used for applications in which flat panels or posters are equipped with NFC or RFID transponders. An interested person may hold a reader, i.e. for example, a mobile device (such as a mobile phone) close to the flat panel or poster and thereby activate communication with the transponder that can be hidden in the flat panel or poster. Due to the large area covered by the antenna or antennas according to the aspects and embodiments of the invention, the reader can be held anywhere close to the flat panel or poster and still receive and/or transmit data.

If the single antenna has a size of A5, two antennas may be used to cover the entire area of an A4 sized flat panel or poster. Four antennas may then be used to cover the area of an A3 sized panel, and generally an n×m antenna matrix can be used to cover any large area.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. An antenna for a transponder, in particular a near field communication (NFC) or radio frequency identification device (RFID) transponder, the antenna comprising:
a plurality of substantially planar coils arranged plane-parallel and side-by-side,
wherein adjacent coils have an opposite sense of winding, if adjacent windings of the adjacent coils run proximate to each other over a substantial distance of the outer circumferential geometrical shape of the adjacent coils.

2. The antenna according to claim 1, wherein the substantial distance is greater than half of the length of one side of the outer geometrical shape of the coil defined by the windings.

3. The antenna according to claim 1, wherein adjacent windings of adjacent coils are proximate to each other if the adjacent windings are closer than half the maximum diameter defined by the outer circumferential geometrical shape of at least one of the adjacent coils.

4. The antenna according to claim 1, wherein the coil are arranged such that pairs of adjacent coils have adjacent wires running substantially in parallel and a current induced by the same external electromagnetic field in a pair of adjacent coils flows in the same direction in the adjacent wires of the pair of adjacent coils.

5. The antenna according to claim 1, wherein each of the coils of the plurality of coils has essentially the same shape and dimension.

6. The antenna according to claim 1, wherein the coils are arranged in a regular pattern.

7. The antenna according to claim 6, wherein the pattern is a checkerboard pattern such that the coils are arranged in rows and columns.

8. The antenna according to claim 1, wherein the windings of the coils are arranged side-by-side in the plane.

9. The antenna according to claim 1, wherein windings of pairs of adjacent coils are arranged side-by-side such that the windings do not overlap each other.

10. The antenna according to claim 1, wherein at least one capacitor is provided within at least one coil in a form of overlapping layers made of the same material as the coils.

11. An antenna arrangement comprising:
a first antenna according to claim 1 and
a second antenna being similar to the first antenna,
wherein the first antenna is arranged on a first side of a substrate and the second antenna is arranged on a second side of the substrate opposite to the first side and
wherein the first antenna is displaced with respect to the second antenna such the first antenna and the second antenna are not exactly superimposed.

12. The antenna arrangement according to claim 10, wherein the first antenna and the second antenna are electrically coupled such that the first antenna and the second antenna form a single antenna.

13. A transponder comprising an antenna according to claim 1 and at least one electronic circuit coupled to the antenna for performing wireless communication through the antenna.

14. The transponder of claim 13, wherein the electronic circuit is an integrated semiconductor circuit and the wireless communication is near field communication (NFC).

15. A flat panel comprising at least one transponder according to claim 13.

16. The flat panel of claim 15, wherein the flat panel is a poster.

17. The flat panel according to claim 15, further comprising soft magnetic foil.
